(19) United States
(12) Patent Application Publication
(10) Pub. No.: US 2010/0087346 A1
(43) Pub. Date: Apr. 8, 2010

(54) Solid film lubricated high oxidation temperature rhenium material

(75) Inventors: William L. Giesler, Phoenix, AZ (US); Robbie J. Adams, Phoenix, AZ (US); Todd A. Langston, Chandler, AZ (US); Margaret M. Floyd, Chandler, AZ (US)

Correspondence Address: HONEYWELL/IFL;Patent Services, 101 Columbia Road, P.O.Box 2245, Morristown, NJ, 07962-2245, US

(73) Assignee: Honeywell International, Inc.

(21) Appl. No.: 11/394,517

(22) Filed: Mar. 31, 2006

(51) Int. Cl. C22C 28/00; C10M 141/06; B05D 1/02; C10M 125/04; C10M 125/02; C10M 141/08

(52) U.S. Cl. 508/123; 508/151; 427/250; 508/150; 420/433

(57) ABSTRACT

The present invention provides a composition that includes a rhenium-based alloy and a solid film lubricant. The rhenium-based alloy comprises an alloying substance including at least one constituent having a stronger affinity to oxygen than does Re when exposed to an atmosphere at a temperature of at least about 285° C.

### TECHNICAL FIELD

The present invention relates to high temperature materials and, more particularly, to oxidation resistant solid film lubricated high temperature materials.

### BACKGROUND

The aerospace industry is continuously seeking to enhance the performance and increase the operational life of launch vehicle components and aerospace applications by increasing the operating temperatures thereof. In some cases, these enhancements can be achieved by changing the material from which the components are made. Materials having properties, such as the capability to withstand high temperatures and pressures that exist in a rocket exhaust environment or aerospace component applications (wear) and sufficient strength and robustness when manufactured as thin members to reduce overall component weight, are desirable. However, few materials exist that possess the aforementioned desired properties.

One example of suitable materials includes refractory metals and refractory metal alloys. In particular, rhenium and rhenium alloys are useful refractory metals for manufacturing aerospace components that require a long operational life in high temperature and/or high pressure environments. Some characteristics that make rhenium and rhenium alloys useful include ultrahigh temperature strength, i.e. 6 to 9 ksi at 4000° F. (2200° C.). Rhenium also has high plastic deformation capability at low temperatures in comparison with many other high melting point metals, which allows it to be a relatively reliable structural material.

Although rhenium and rhenium alloys provide many advantages, they still may suffer from drawbacks under certain circumstances. For example, in some launch vehicles or aerospace component applications, a foil air bearing, valve bushings, guide vane bushings, finger or brush seals, pistons, face seals, or other assemblies that operate by sliding contact between two or more components may be included. In these cases, components constructed with current state of the art materials may exhibit high friction coefficients above 1.0 during operation while subjected to operating temperatures. Consequently, the components may more rapidly build local heat during operation resulting in softening of the component material. Therefore, the components may become worn and loads thereon may increase.

Hence, there is a need for a suitable high temperature material that may be used for the construction or coating of components that can self lubricate when in sliding contact with other components. Additionally, it is desirable for the high temperature material to not only have a sufficiently high melting temperature and high temperature strength and stability to maintain desirable physical and chemical properties in extreme environments, but also an ability not to be adversely affected by exposure to oxygen, particularly in these environments. Further, there is a need for the material to have relatively high ductility at high temperatures.

### BRIEF SUMMARY

The present invention provides a composition that includes a rhenium-based alloy and a solid film lubricant. The rhenium-based alloy comprises an alloying substance including at least one constituent having a stronger affinity to oxygen than does Re when exposed to an atmosphere at a temperature of at least about 285° C.

In another embodiment, and by way of example only, a method is provided of forming an oxidation-resistant, self lubricating coating on a substrate surface. The method includes the step of method of forming an oxidation-resistant, self lubricating coating on a substrate surface.

In still another embodiment, and by way of example only, another method is provided that includes the step of metal spraying a material comprising a rhenium-based alloy and a solid film lubricant onto the substrate surface, wherein the rhenium-based alloy comprises an alloying substance including at least one constituent having a stronger affinity to oxygen than does Re when exposed to an atmosphere at a temperature of at least about 285° C.

Other independent features and advantages of the preferred high temperature material will become apparent from the following detailed description, taken in conjunction with the accompanying drawings which illustrate, by way of example, the principles of the invention.

### BRIEF DESCRIPTION OF THE DRAWINGS

FIG. 1 is a flow chart depicting an exemplary method for forming an exemplary coating on a substrate; and

FIG. 2 is a cross-sectional view of a workpiece having the exemplary coating formed thereon using an exemplary cold spraying process.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

An improved high temperature material is provided that may be used in a variety of applications, and in particular, may be used to construct or coat an aircraft component that may be in sliding contact with another component during aircraft operation. The high temperature material has high strength, high ductility, corrosion resistance, oxidation resistance, thermal fatigue resistance, and has a friction coefficient of less than about 1.0 when subjected to temperatures in the range of about 1000° F. (530° C.). The high temperature material is broadly defined as comprising a rhenium-based alloy and a solid film lubricant. The rhenium-based alloy and solid film lubricant may be combined as a mixture or alloyed with one another.

The rhenium-based alloy is formulated to resist oxidation when exposed to an oxygenated atmosphere having a temperature of at least about 550° F. (285° C.). The rhenium-based alloy includes Re and an alloying substance. Preferably, Re is present at least about 50% by atomic percent within the rhenium-based alloy component; however, it will be appreciated that any other suitable concentration may alternatively be employed such that the rhenium-based alloy maintains a rhenium-based structure.

The alloying substance comprises one or more constituents having a stronger affinity for oxygen than Re and, when added to Re, causes the resulting rhenium-based alloy to have an oxidation-resistance that is improved over pure Re. Preferably, the alloying substance has partial to high solubility with rhenium. In one exemplary embodiment, the alloying substance includes one or more constituents selected from Co, Cr, and Mn. For example, the alloying substance may include Co at a concentration of up to about 50% by atomic percent of the rhenium-based alloy. In another embodiment, the alloying substance includes, in addition to Co, Cr that is present at a concentration of up to about 15% by atomic percent of the rhenium-based alloy, more preferably at least about 10% by atomic percent. In still another embodiment, the alloying substance further includes, in addition to Co and Cr, Mn that is present at a concentration of up to about 10% by atomic percent of the rhenium-based alloy, more preferably at least about 5% by atomic percent. In an exemplary embodiment in which the alloying substance includes Co, Cr, and Mn, most preferably, Re is present at a concentration of about 60% by atomic percent, Co is present at a concentration of about 20% by atomic percent, Cr is present at a concentration of about 15% by atomic percent, and Mn is present at a concentration of about 5% by atomic percent.

In another exemplary embodiment, in which the rhenium-based alloy includes Co, Cr, and Mn, Ni may further be included. In these embodiments, Ni may be present at a concentration of up to about 15% by atomic percent of the rhenium-based alloy. In a preferred embodiment, Re is present at a concentration of about 55% by atomic percent, Co is present at a concentration of about 20% by atomic percent, Cr is present at a concentration of about 10% by atomic percent, Mn is present at a concentration of about 5% by atomic percent, and Ni is present at a concentration of about 10% by atomic percent. In still yet other embodiments, the alloying substance may optionally further include one or more other constituents having partial to high solubility with rhenium and an affinity for oxygen and an ability to increase the oxidation-resistance of Re that include, but are not limited to V, Si, Al, Y, Ti, Th, and Hf. It will be appreciated that in all of the various embodiments, the balance of the concentration is preferably Re, though the balance could be Re and one or more other elements that may, for example, be present in trace amounts

The solid film lubricant may be either a single component or composite material that provides lubrication or friction reduction at various temperatures, contact pressures, and contact velocities. The composition of the solid film lubticant may be selected to enhance properties such as self and mating pair polishing, burnishing, material transfer and amount of material transfer thickness before hard particles burnish off any approachable thickness of the transfer film. Any one of numerous suitable materials having the previously described properties may be employed, including, but not limited to molybdenum disulfide, cubic boron nitride, silver, polytetrafluoroethylene, barium fluoride, calcium fluoride, barium fluoride-calcium fluoride eutectic, chromium oxide, boron, boron nickel, antimony, magnesium fluoride, barium fluoride-calcium fluoride-magnesium fluoride eutectic, magnesium silicate (talc), chromia, and calcium sulfate.

In one exemplary embodiment, the solid film lubricant includes Cr₂O₃, BaF₂/CaF₂, and Ag as constituents. In this embodiment, the rhenium alloy may be present at a concentration of between about 40% and about 76% by atomic percent, Cr₂O₃ may be present at a concentration of between about 13% and about 40% by atomic percent, Ag may be present at a concentration of between about 6.0% and about 11% by atomic percent, and BaF₂/CaF₂ may be present at a concentration of between about 5% and about 10% by atomic percent.

In another exemplary embodiment, the solid film lubricant comprises chromium oxide and metal fluoride. The metal fluoride component comprises a fluoride salt of at least one metal selected from Group I metals, Group II metals, and rare earth metals. More particularly, the metal fluoride component preferably comprises a fluoride of at least one metal selected from the group consisting essentially of a Group IA alkali earth metal, a Group IIA alkaline earth metal, or mixtures thereof. In some embodiments, low temperature lubricating metal components may be included. Low temperature lubricating components include one or more metals (such as one or more noble metals) that are sufficiently flexible to provide lubrication at low temperatures, including cryogenic temperatures, yet exhibit oxidation resistance along with a high enough melting temperature to enable it to be used over a broad temperature range. Useful low temperature metals include at least one metal selected from the group consisting essentially of Ag, Au, Pt, Pd, Rh, Cu and mixtures thereof.

One exemplary embodiment of the high temperature material includes the rhenium-based alloy in an amount ranging from between about 5% and about 99% by atomic percent and the solid film lubricant. The solid film lubricant includes between about 1% and about 99% by atomic percent of chromium oxide, between about 1% and about 25% by atomic percent of a metal fluoride, wherein the metal fluoride comprises a fluoride of at least one metal selected from the group consisting of a metal of Group IA alkali earth metal, Group IIA alkaline earth metal, rare earth metal and mixtures thereof, and optionally, between about 1% and about 25% by atomic percent of a low temperature metal lubricant selected from the group consisting of Ag, Au, Pt, Pd, Rh, Cu and mixtures thereof.

In another exemplary embodiment, the high temperature material includes the rhenium-based alloy in an amount between about 25% and about 75% by atomic percent and the solid film lubricant. The solid film lubricant includes between about 12% and about 65% by atomic percent of chromium oxide, between about 1% and about 25% by atomic percent of a metal fluoride, wherein the metal fluoride comprises a fluoride of at least one metal selected from the group consisting of a metal of Group IA alkali earth metal, Group IIA alkaline earth metal, rare earth metal and mixtures thereof, and optionally, between about 3% and about 35% by atomic percent of one or more low temperature lubricating metals selected from the group consisting of Ag, Au, Pt, Pd, Rh, Cu and mixtures thereof.

In still another exemplary embodiment, the high temperature material includes the rhenium-based alloy in an amount between about 24% and about 75% by atomic percent and the solid film lubricant. The solid film lubricant includes between about 12% and about 55% by atomic percent of chromium oxide, between about 4% and about 21% by atomic percent of metal fluoride, wherein the metal fluoride comprises a eutectic mixture of barium and calcium fluorides, and optionally, between about 4% and about 21% by atomic percent of one or more low temperature lubricating metals selected from the group consisting of Ag, Au, Pt, Pd, Rh, Cu and mixtures thereof.

In still yet another exemplary embodiment, the high temperature material includes the rhenium-based alloy and solid film lubricant, where the solid film lubricant includes between about 45% and about 70% by atomic percent of chromium oxide, between about 3% and about 12% by atomic percent of a metal fluoride, the metal comprising at least one metal selected from the group consisting of a metal of Group IA, Group IIA, rare earth metal and mixtures thereof, and optionally, between about 3% and about 27% by atomic percent of a low temperature metal lubricant selected from the group consisting of Ag, Au, Pt, Pd, Rh, Cu and mixtures thereof.

As briefly mentioned above, the high temperature material may be used to construct or coat a component that may abrade against another component. It will be appreciated that the component may be constructed using any one of numerous conventional technique suitable for forming the high temperature material into a desired component configuration. For example, the high temperature material may be applied by a high temperature isostatic pressure process, a free form fabrication process, casting process, any metal spraying process, such as plasma spraying, sputtering, high velocity oxygen fuel spraying, detonation gun spraying, super detonation gun spraying, any deposition process, such as chemical vapor deposition or plasma vapor deposition, or any other suitable conventional technique.

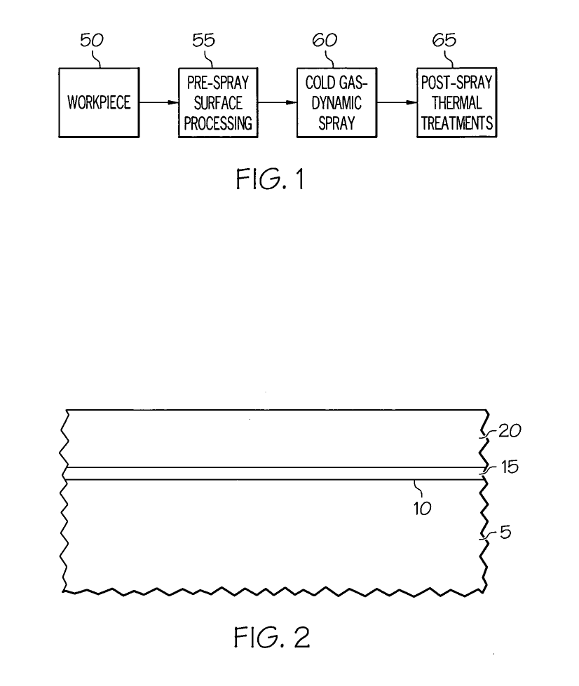

Similarly, any one of numerous processes, either high temperature or low temperature and preferably low cost, may be employed to apply the high temperature material onto a component as an oxidation-resistant, self lubricating coating. One exemplary coating process includes a cold spray dynamic technique. Turning now to FIG. 1, an exemplary method for forming the coating is depicted. First, a workpiece is selected at step 50 based on a need for an oxidation-resistant, self lubricating coating on its surface. FIG. 2 is a cross-sectional view of an exemplary workpiece 5 having a surface 10 coated with an oxidation-resistant, self lubricating coating 20. The workpiece 5 shown in FIG. 2 is an aerospace engine component such as a face seal, however, any one of numerous other types of workpieces in various technologies may benefit from an oxidation-resistant, self lubricating coating applied using the method outlined in FIG. 1. Iron-based alloys and superalloys including steel, and preferably stainless steel alloys, may be suitable types of substrates for receiving the oxidation-resistant, self lubricating coating 20, as are substrates formed from nickel-based alloys and superalloys.

After selecting the workpiece 5, the targeted workpiece surface 10 is prepared for receiving the oxidation-resistant, self lubricating coating 20, step 55. For example, the workpiece surface 10 may be prepared using surface rebuilding steps, pre-machining, degreasing, and grit blasting, which may remove oxidation or contamination that may be present thereon. Pre-spraying surface processing may further include forming an intermediate layer 15 on the workpiece surface 10. The intermediate layer may be applied by a conventional technique such as electroplating, or by a cold spraying process, and may be formed from using a material that is soluble with both the alloy forming the workpiece surface and the material that will form the oxidation-resistant, self lubricating coating 20. For example, if the coating 20 is to be formed on a steel substrate, one exemplary intermediate layer would be formed from nickel, since nickel is soluble with both rhenium and steel. Depending on the particular materials from which the oxidation-resistant, self lubricating coating and workpiece are made, other suitable materials for forming the intermediate layer may include, but are not limited to, one or more different elements such as chromium, cobalt, zirconium, vanadium, titanium, tantalum, silicon, scandium, rhodium, platinum, palladium, osmium, columbium, molybdenum, manganese, iridium, hafnium, iron, chromium, beryllium, and boron.

Upon preparing the workpiece surface 10, the oxidation-resistant, self lubricating coating 20 is formed by cold spraying a high temperature material onto the workpiece surface 10 and/or the intermediate layer 15 if present, step 60. During a cold gas spraying process, particles at a temperature below their melting temperature are accelerated and directed to the targeted surface 10. When the particles strike the targeted surface 10, the particle kinetic energy causes the particle to plastically deform and form a mechanical bond with the targeted surface 10. Any of the previously-discussed high temperature materials may be used. The spraying step 60 forms the oxidation-resistant, self lubricating coating 20 and generally maintains the component's desired dimensions, although additional machining can be performed if necessary to accomplish dimensional restoration.

After spraying, thermal treatments may be performed as necessary or as desired to cause the separate metal elements within the oxidation-resistant, self lubricating coating 20, and at the interface between the coating 20 and the substrate 10 and/or the intermediate layer 15, to diffuse as desirable. An exemplary thermal treatment includes one or more processes such as a heat treatment, a hot isostatic pressing treatment, or a sintering treatment such as vacuum sintering, to form the desired alloy or superalloy with a substantially uniform microstructure and composition.

A high temperature material and method for using the high temperature material has now been provided. The high temperature material can be used for the construction or coating of components and that is not adversely affected by exposure to oxygen, particularly at very high temperatures and pressures. Moreover, the high temperature material is self lubricating in that it has a friction coefficient of less than 1.0. Additionally, the high temperature material has a high melting temperature and relatively high ductility and strength at high temperatures.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising:
a rhenium-based alloy comprising an alloying substance including at least one constituent selected from the group consisting of Co, Cr, and Mn, the alloying substance having a stronger affinity to oxygen than does Re when exposed to an atmosphere having a temperature of at least about 285° C.; and
a solid film lubricant comprising at least one constituent selected from the group consisting of molybdenum disulfide, cubic boron nitride, silver, polytetrafluoroethylene, barium fluoride, calcium fluoride, barium fluoride-calcium fluoride eutectic, chromium oxide, boron, boron nickel, antimony, magnesium fluoride, barium fluoride-calcium fluoride-magnesium fluoride eutectic, magnesium silicate (talc), zinc phosphate, graphite carbon, and calcium sulfate.

2. (canceled)

3. The composition of claim 1, wherein the rhenium-based alloy comprises at least about 50% Re by atomic percent.

4. The composition of claim 1, wherein the alloying substance comprises Co, Cr, and Mn.

5. The composition of claim 4, wherein the alloying substance further comprises up to about 50% Co by atomic percent.

6. The composition of claim 4, wherein the alloying substance further comprises up to about 15% Cr by atomic percent.

7. The composition of claim 4, wherein the alloying substance further comprises up to about 10% Mn by atomic percent.

8. The composition of claim 4, wherein the alloying substance further comprises Ni.

9. The composition of claim 8, further comprising up to about 15% Ni by atomic percent.

10. The composition of claim 4, wherein the alloying substance further comprises at least one constituent selected from the group consisting of vanadium, silicon, aluminum, yttrium, hafnium, and thorium.

11. (canceled)

12. The composition of claim 1, wherein:
the solid film lubricant comprises:
chromium oxide; and
metal fluoride, wherein the metal fluoride comprises a fluoride of at least one metal selected from the group consisting of a Group IA alkali earth metal, a Group IIA alkaline earth metal, rare earth metal, and mixtures thereof; and
optionally, one or more low temperature lubricating metals selected from the group consisting of Ag, Au, Pt, Pd, Rh, Cu and mixtures thereof.

13. The composition of claim 12, wherein:
the rhenium-based alloy is present in an amount ranging from between about 5% and about 99% by atomic percent; and
the solid film lubricant comprises:
between about 1% and about 99% by atomic percent of chromium oxide;
between about 1% and about 25% by atomic percent of a metal fluoride, wherein the metal fluoride comprises a fluoride of at least one metal selected from the group consisting of a metal of Group IA alkali earth metal, Group IIA alkaline earth metal, rare earth metal and mixtures thereof; and
optionally, between about 1% and about 25% by atomic percent of a low temperature metal lubricant selected from the group consisting of Ag, Au, Pt, Pd, Rh, Cu and mixtures thereof.

14. The composition of claim 12, wherein:
the rhenium-based alloy is present in an amount between about 25% and about 75% by atomic percent; and
the solid film lubricant comprises:
chromium oxide, wherein the amount of chromium oxide present in the solid film lubricant ranges from between about 12% and about 65% by atomic percent; and
between about 3% and about 16% by atomic percent of metal fluoride, wherein the metal fluoride comprises a fluoride of at least one metal selected from the group consisting of a metal of Group IA alkali earth metal, Group IIA alkaline earth metal, rare earth metal and mixtures thereof; and
optionally, between about 3% and about 35% by atomic percent of one or more low temperature lubricating metals selected from the group consisting of Ag, Au, Pt, Pd, Rh, Cu and mixtures thereof.

15. The composition of claim 12, wherein the solid film lubricant comprises:
between about 45% and about 70% by atomic percent of chromium oxide;
between about 3% and about 12% by atomic percent of a metal fluoride, the metal comprising at least one metal selected from the group consisting of a metal of Group IA, Group IIA, rare earth metal and mixtures thereof; and
optionally, between about 3% and about 27% by atomic percent of a low temperature metal lubricant selected from the group consisting of Ag, Au, Pt, Pd, Rh, Cu and mixtures thereof.

16. The composition of claim 12, wherein:
the rhenium-based alloy is present in an amount between about 24% and about 75% by atomic percent; and
the solid film lubricant comprises:
chromium oxide, wherein the amount of chromium oxide present in the solid film lubricant ranges from between about 12% and about 55% by atomic percent; and
between about 4% and about 21% by atomic percent of metal fluoride, wherein the metal fluoride comprises a eutectic mixture of barium and calcium fluorides; and
optionally, between about 4% and about 21% by atomic percent of one or more low temperature lubricating metals selected from the group consisting of Ag, Au, Pt, Pd, Rh, Cu and mixtures thereof.

17. The composition of claim 1, wherein the solid film lubricant comprises NiCr, Cr₂O₃, BaF₂/CaF₂, and Ag.

18. The composition of claim 17, further comprising:
between about 40% and about 76% by atomic percent of the rhenium-based alloy;
between about 13% and about 40% by atomic percent Cr₂O₃; and
between about 5% and about 10% by atomic percent BaF₂/CaF₂; and
between about 6.0% and about 11% by atomic percent Ag.

19. A method of forming an oxidation-resistant, self lubricating coating on a substrate surface, comprising the step of:
cold gas-dynamic spraying a material comprising a rhenium-based alloy and a solid film lubricant onto the substrate surface, wherein the rhenium-based alloy comprises an alloying substance including at least one constituent having a stronger affinity to oxygen than does Re when exposed to an atmosphere at a temperature of at least about 285° C.

20. A method of forming an oxidation-resistant, self lubricating coating on a substrate surface, comprising the step of:
metal spraying a material comprising a rhenium-based alloy and a solid film lubricant onto the substrate surface, wherein the rhenium-based alloy comprises an alloying substance including at least one constituent having a stronger affinity to oxygen than does Re when exposed to an atmosphere at a temperature of at least about 285° C.
